(19) United States
(12) Patent Application Publication
(10) Pub. No.: US 2002/0094188 A1
(43) Pub. Date: Jul. 18, 2002

(54) Observing apparatus for optical fiber, optical component

(76) Inventors: Hidekazu Kojima, Tokyo (JP); Takaaki Uchida, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/961,702

(22) Filed: Sep. 21, 2001

Related U.S. Application Data
(63) Continuation of application No. PCT/JP01/03561, filed on Apr. 25, 2001.

(30) Foreign Application Priority Data
Apr. 26, 2000 (JP) 2000-125693

(51) Int. Cl. G02B 6/00

(52) U.S. Cl. 385/147

(57) ABSTRACT

A vertically-placed TV camera to be disposed such that the direction of scanning lines thereof is orthogonal to the optical axis of an optical fiber or the like to be connected and a laterally-placed TV camera to be disposed such that the direction of the scanning lines thereof is parallel to the same optical axis are prepared, so that images from those TV cameras can be displayed on a TV monitor. Further, an image processing portion capable of outputting an image from the TV cameras to the TV monitor and processing the image from the TV camera and outputting desired information about the optical fibers to be connected is provided, and each of the aforementioned TV cameras is provided with an optical system. The optical system of the TV camera has a higher magnification than that of the TV camera. The image processing portion turns an image from the TV camera at 90° and matches an image from the TV camera therewith in terms of the scanning direction and outputs the image to the TV monitor.

### TECHNICAL FIELD

The present invention relates to an observing apparatus for optical fiber, optical component, for, upon connecting optical fibers or optical components to each other or connecting an optical fiber to an optical component, observing the same connection objects so that optical axes of those connection objects are aligned with each other, and more particularly to an observing apparatus suitable for combination with a fusion-splicing apparatus.

### BACKGROUND ART

Conventionally, in the fusion-splicing apparatus for the optical fiber, optical component, these connection objects are photographed with one or two or more TV cameras and then, the captured image is processed so as to obtain position information of those connection objects and the same connection objects are moved on the basis of the position information so as to align the optical axes thereof. Then, the captured image or a picture obtained by processing that captured image in a predetermined manner is displayed on a TV monitor so that an operator can observe the same connection objects.

In the case where the fusion-splicing apparatus using the above-described image process is provided with two or more TV cameras for capturing images of such connection objects as the optical fibers and the like, all the TV cameras are disposed such that scanning lines thereof coincide with each other in order to simplify the circuit structure of the image processing apparatus, which fetches images from the respective TV cameras and which processes the fetched images (synthesizing and the like). This means that the vision fields of all the TV cameras are matched with each other.

For connecting the optical fibers, the optical components, preferably, rough positioning is carried out by observing the connection objects in a wide field of vision at a low magnification and next, final positioning (alignment of the optical axis) is executed by carrying out a high precision observation in a narrow field of vision at a high magnification. Particularly, ribbon fiber having eight or more optical fibers needs to be treated in such a way. However, conventionally, even if two or more TV cameras are provided, two-stage observation comprised of such observation in a wide field of vision at a low magnification and observation in a narrow field of vision at a high magnification cannot be executed because all the TV cameras have the same vision field. To solve this problem, Japanese Patent Application Laid-Open No. 7-84190 has proposed installation of microscopes having different magnifications to plural TV cameras. However, with such a treatment alone, resolution of a TV camera in the direction of axis shift of the optical fibers to be connected is low, so that an image preferable for high prevision alignment of the optical axes cannot be obtained. That is, in an ordinary camera in the ratio of 4:3 (Horizontal:Vertical), the ratio of its resolution capacity is also 4:3 or the resolution capacity in the lateral direction is higher. However, the characteristic of this TV camera is not exerted sufficiently.

An object of the present invention is to provide an observing apparatus for optical fiber, optical component, which makes the best use of the characteristics of the TV camera and which provides a preferable image meeting each observation E purpose. More specifically, an object of the present invention is to provide an observing apparatus for optical fiber, optical component capable of providing observation image in a wide field of vision at a low magnification and observation image in a narrow field of vision at high magnification in which observation image in a narrow field of vision at a high magnification has a higher resolution than observation image in a narrow field of vision at a low magnification, so as to ensure a high precision alignment.

### DISCLOSURE OF THE INVENTION

According to an aspect of the present invention, there is provided an observing apparatus for optical fiber, optical component for observing the optical fiber, the optical component based on a picture obtained by processing an image captured with two or more TV cameras about the optical fiber, the optical component, the observing apparatus comprising a vertically-placed TV camera disposed such that the direction of scanning lines thereof is orthogonal to the optical axis of the optical fiber or the like which is an object for capturing picture and a laterally-placed TV camera disposed such that the direction of scanning line is parallel to the optical axis of the optical fiber or the like, so that a picture obtained by processing the image captured with the TV camera is displayed on the TV monitor so as to observe the optical fiber, the optical component.

According to another aspect of the present invention, there is provided an observing apparatus for optical fiber, optical component for observing the optical fiber and the like based on an image obtained by processing an image captured with two or more TV cameras about the optical fiber and the optical component, the observing apparatus comprising a vertically-placed TV camera disposed such that the direction of scanning lines thereof is orthogonal to the optical axis of the optical fiber or the like which is an object for capturing image, a laterally-placed TV camera disposed such that the direction of scanning line is parallel to the optical axis of the optical fiber or the like, and an image processing portion capable of outputting the image from the TV camera to a TV monitor and further processing an image from the TV camera and outputting desired information about the optical fiber and the like, the TV camera containing an optical system for capturing images of the optical fiber or the like which is an object for capturing images, in enlargement, the optical system provided on the vertically-placed TV camera ensuring a higher magnification than the optical system provided on the laterally-placed TV camera, the image processing portion turning an image sent from the vertically-placed TV camera at 90°, matching an image sent from the laterally-placed TV camera therewith in terms of their scanning directions and outputting the image to the TV monitor.

According to still another aspect of the present invention, there is provided the observing apparatus for the optical fiber, optical component wherein the image from the respective TV cameras is reduced and outputted to the TV monitor as an image for a single screen and images from the respective TV cameras can be switched over and outputted to the TV monitor separately.

### BRIEF DESCRIPTION OF DRAWINGS

FIG. 1 is an explanatory diagram showing a first principal of the observing apparatus for the optical fiber, optical component of the present invention;

FIG. 2 is a schematic diagram of a fusion-splicing apparatus employing the observing apparatus for the optical fiber, optical component of the present invention;

FIG. 3 is an explanatory diagram showing a first embodiment of the observing apparatus for the optical fiber, optical component of the present invention;

FIG. 4 is an explanatory diagram showing a circuit structure of an image processing portion;

FIG. 5 is an explanatory diagram showing a second principle of the observing apparatus for the optical fiber, optical component of the present invention; and

FIG. 6 is an explanatory diagram showing a second embodiment of the observing apparatus for the optical fiber, optical component of the present invention.

### BEST MODE FOR CARRYING OUT THE INVENTION

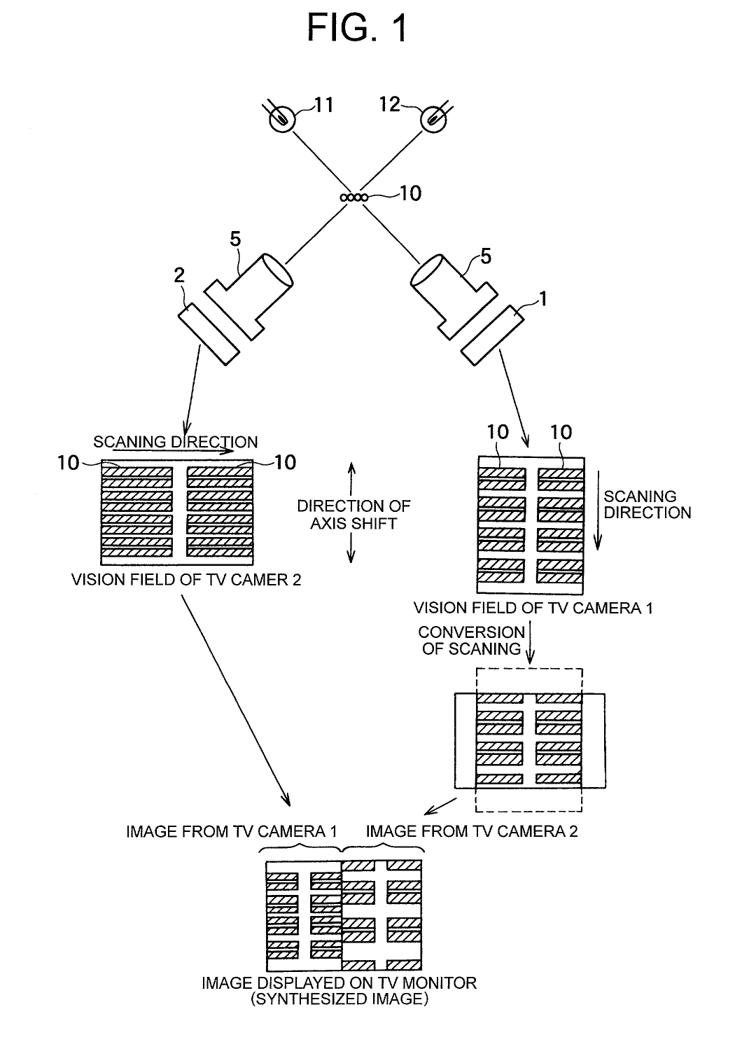

Prior to description of the preferred embodiments of the present invention, first, the principle of the observing apparatus for the optical fiber, optical component of the present invention will be described about a case where the observation object is a ribbon fiber as an example. In the observation apparatus for the optical fiber, optical component of the present invention, as shown in FIG. 1, two TV cameras 1, 2 are provided and the TV camera 1 is disposed such that the scanning line is orthogonal to the optical axis of a ribbon fiber 10 while the TV camera 2 is disposed such that the scanning line is parallel to the optical axis of the ribbon fiber 10. Consequently, the field of vision of the TV camera 1 (vertically-placed TV camera 1) provided such that the scanning line is orthogonal to the optical axis of the ribbon fiber 10 and the field of vision of the TV camera 2 (laterally-placed TV camera 2) provided such that the scanning line is parallel to the optical axis of the ribbon fiber 10 are different from each other. Further, the vertically-placed TV camera 1 is provided with a high magnification optical system 5 (microscope 5) while the laterally-placed TV camera 2 is provided with a low magnification optical system 5 (microscope 5). Consequently, the laterally-placed TV camera 2 obtains an image in a wide field of vision at a low magnification (laterally longer) suitable for rough positioning (optical axis alignment) of the ribbon fiber 10, while the vertically-placed TV camera 1 obtains an image in a narrow field of vision at a high magnification (longitudinally longer) suitable for high precision positioning of the same fiber 10. An image from the aforementioned vertically-disposed TV camera 1 is turned at 90° by an image processing portion (not shown) so that the scanning direction is matched with that of an image from the laterally-disposed TV camera 2 and then both images are synthesized and outputted to a TV monitor (not shown). Meanwhile, reference numerals 11, 12 denote light sources for illuminating the ribbon fiber while the light source 11 is used for capturing images by the vertically-placed TV camera 1 and the light source 12 is used for capturing images by the laterally-placed TV camera 2.

First embodiment

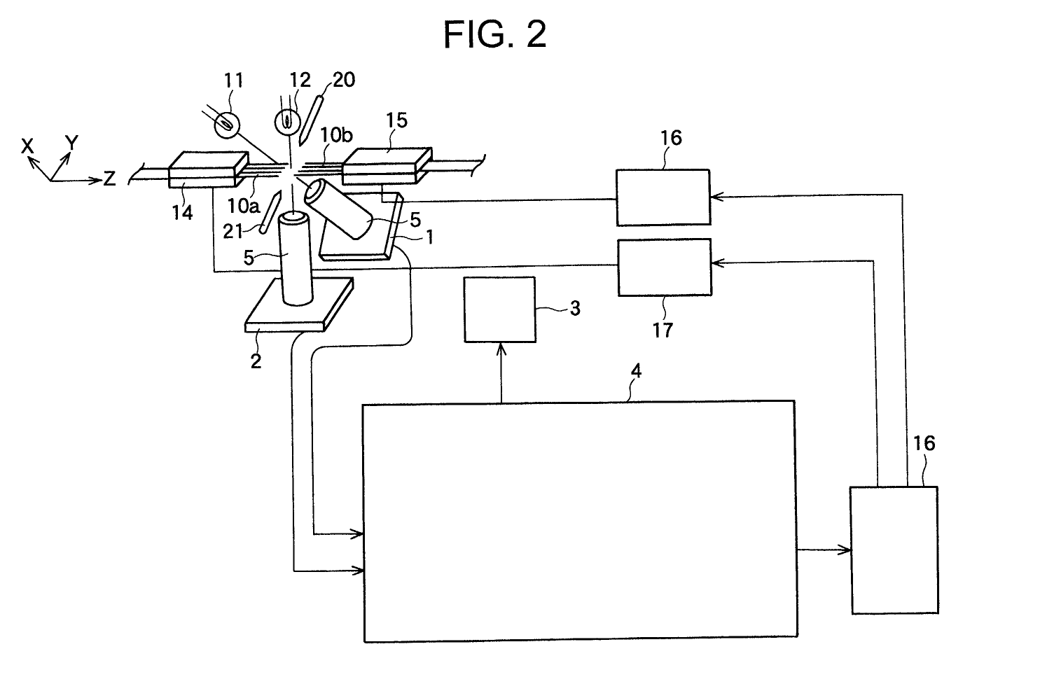

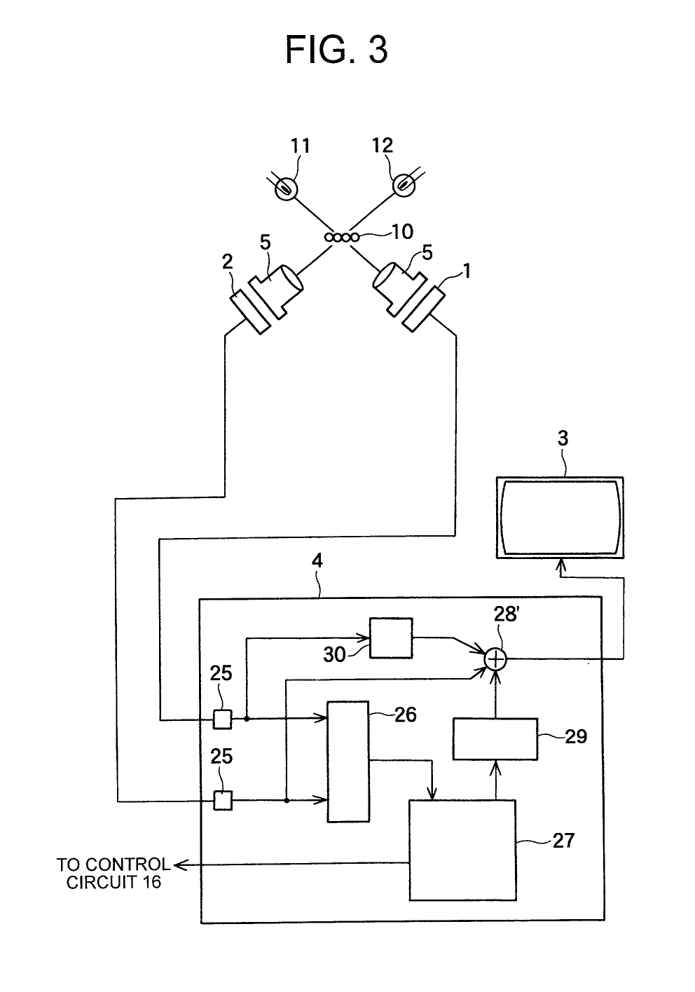

The first embodiment of the observation apparatus for the optical fiber, optical component of the present invention, which is achieved by embodying the principle described above, will be described in detail with reference to FIGS. 2, 3. FIG. 2 is a schematic diagram of an optical fiber fusion-splicing apparatus having the observation apparatus for the optical fiber, optical component of the present invention. This apparatus has positioning members 14, 15, which can be moved in each axis of the X, Y, Z directions. The respective positioning members 14, 15 are capable of setting ribbon fibers (optical fiber) 10a, 10b whose end portions are butted to each other. The vertically-placed TV camera 1 and laterally-placed TV camera 2 composing the observation apparatus for the optical fiber, optical component of the present invention are disposed near the butting portions of the ribbon fibers 10a, 10b. The respective TV cameras 1, 2 are disposed at a position in which they are capable of capturing images of the ribbon fibers 10a, 10b illuminated from the light sources 11, 12 from a direction orthogonal to the optical axes thereof. Images captured with these TV cameras 1, 2 are processed by the image processing portion 4 composing the observation apparatus for the optical fiber, optical component of the present invention. A result of process by the image processing portion 4 is outputted to a control circuit 16 of the fusion-splicing apparatus and then, signals are outputted to fiber position control circuits 17, 18 from the same circuit 16. The positioning members 14, 15 are moved according to those signals so that the ribbon fibers 10a, 10b are positioned (optical axis is aligned). After that, the ribbon fibers 10a, 10b are connected by fusion splicing by discharge between electrode rods 20, 21. The image process by the image processing portion 4 and moving of the positioning members 14, 15 based on the processing result are repeated several times, so that the optical axis is aligned gradually.

The vertically-placed TV camera 1 is provided such that the scanning line is orthogonal to the optical axes of the ribbon fibers 10a, 10b and the laterally-disposed TV camera 2 is provided such that the scanning line is parallel to the optical axes of the same fibers 10a, 10b. The respective TV cameras 1, 2 are provided with the microscope 5 for capturing images of the butting portion of the ribbon fibers 10a, 10b in enlargement. The microscope 5 provided on the vertically placed TV camera 1 has a higher magnification than the microscope 5 provided on the laterally-placed TV camera 2. As a result, an image captured in a wide field of vision at a low magnification suitable for rough positioning of the ribbon fibers 10a, 10b is obtained by the laterally-placed TV camera 2 and an image captured in a narrow field of vision at a high magnification suitable for final alignment of the same fibers 10a, 10b is obtained by the vertically-placed TV camera 1. Further, because as shown in FIG. 1, the vertically-placed TV camera 1 is disposed such that the scanning line is orthogonal to the optical axes of the ribbon fibers 10a, 10b (In other words, the direction of the scanning line, which is parallel to the direction of shift of each of the ribbon fibers 10a, 10b=the direction of the shift of the axis in which the resolution is higher than any other direction), an image having a high resolution is obtained in the direction of the axis shift of each of the same fibers 10a, 10b.

In the aforementioned image processing portion 4, as shown in FIG. 3, video signals from the vertically-placed TV camera 1 and the laterally-placed TV camera 2 are converted to digital signal by the A/D converter 25. These digital signals are branched while one thereof is fetched into a frame memory 26, subjected to image process by a calculator 27 and then its result is outputted to the control circuit 16 (FIG. 2). The other is sent to a synthesizing circuit 28, synthesized with video signal from a graphic circuit 29 and outputted to the TV monitor 3. At this time, a signal from the vertically-placed TV camera 1, which observes at a high magnification, is inputted to a scanning converter 30 before inputted to the synthesizing circuit 28, and its image is turned at 90° so as to coincide with the type of a signal from the laterally-placed TV camera 2 which observes at a low magnification. Meanwhile, a video signal outputted from the graphic circuit 29 includes text data or graphic data of information which is an image processing result of the calculator 27 and images from the TV cameras 1, 2 are superimposed on the synthesized image by the synthesizing circuit 28. In this case, for example, an image from the TV camera 1 or 2 is offset to the left side of the screen, while an image on which the text data or graphic data generated by the graphic circuit 29 is displayed in a space on the right side.

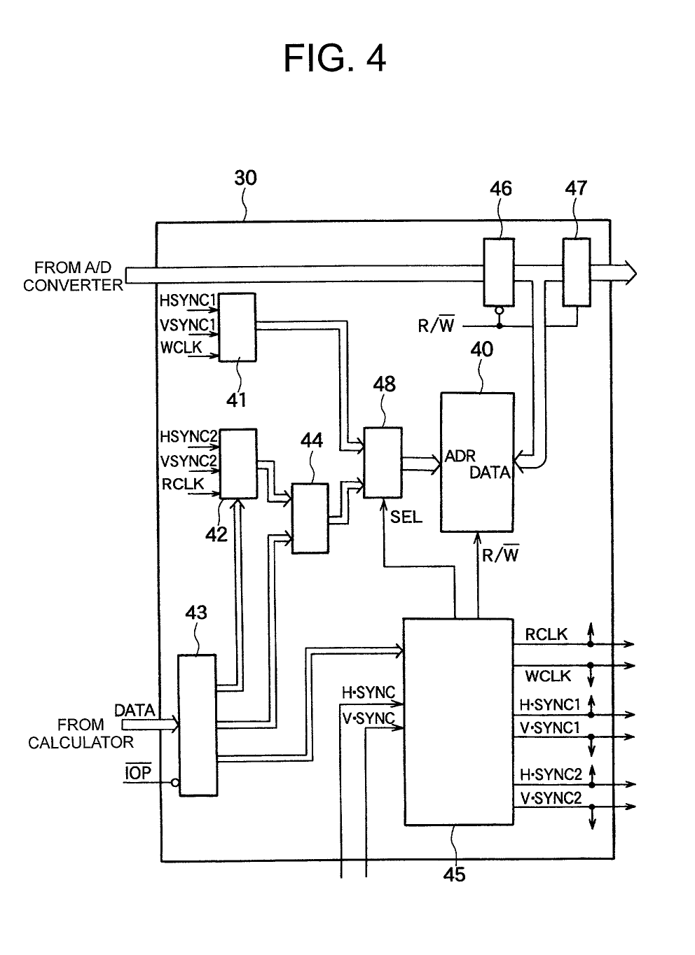

FIG. 4 shows a circuit structure of the scanning converter 30 in the concrete, which contains a memory 40 capable of storing data executed AD convert corresponding to at least one screen of the image from the TV camera 1 and other various circuits for controlling writing of the image into this memory 40 and reading of the image from the memory 40. Writing of images (image data) into the memory 40 and reading of the image data from the memory 40 will be described below.

A write address counter 41 of FIG. 4 generates an address for image data writing into the memory 40 using synchronous signals HSYNC1 (horizontal synchronous signal) and VSYNC1 (vertical synchronous signal) for use in control of the TV camera 1. A read address counter 42 generates an address for reading image data from the memory 40 using synchronous signals HSYNC2 and VSYNC2 for use in control of the TV monitor 3. A data latch 43 outputs a signal to the read address counter 42 based on image magnification setting information stored in the same data latch 43 so as to change an address for reading out image of the same counter 42, so that any image can be read out from the memory 40 at any magnification. Further, the data latch 43 outputs a signal to an adder 44 based on image offset setting information stored in the same data latch 43 and adds an offset value corresponding to this image offset setting information to an address from the read address counter 42, so that any offset image can be read out from the memory 40. The write address counter 41 and the read address counter 42 are so constructed that the vertical direction of the screen and the horizontal direction of the screen can be exchanged. If image data is written into the memory 40 using an address from the write address counter 41 while image data is read out from the memory 40 using an address from the read address counter 42, the image data (image) is displayed such that it is turned at 90° with respect to a captured image of the TV camera 1.

A read/write control circuit 45 of FIG. 4 generates various kinds of signals necessary for controlling the scanning converter 30 based on synchronous signals HSYNC and VSYNC (from synchronous signal generator (not shown) and setting information stored in the data latch 43. In this case, write in signal WCLK and read out signal RCLK for video signal data, synchronous signals HSYNC1, VSYNC1 for the TV camera 1, synchronous signals HSYNC2, VSYNC2 for the TV monitor 3, memory address switch-over signal SEL and memory read/write switch-over signal R/W are generated. Then, write and read into/from the memory 40 are carried out once each in a unit time of a pixel. The image data from the TV camera 1 is transmitted to the memory 40 through a data buffer 46 according to a signal outputted from the read/write control circuit 45 and image data for display on the TV monitor 3 is read out from the memory 40 through a read data buffer 47. The data read/write timings through the write data buffer 46 and the read data buffer 47 are controlled in various ways according to the read/write switch-over signal R/W.

An outline of the operation of the scanning converter 30 will be described. If the synchronous signals HSYNC1 and VSYNC1 from the read/write control circuit 45 are inputted into the TV camera 1, a video signal is outputted from the same TV camera 1 along this synchronous signal and then, that video signal is accumulated on the write data buffer 46 through the A/D converter 25. The image data is transmitted from the write data buffer 46 to the memory 40 according to the write signal RCLK and memorized. An address from the write in address counter 41, which integrates write address corresponding to scanning of the vertically-placed TV camera 1 with the synchronous signals HSYNC1 and VSYNC1 is selected by a selector 48 and transmitted to the memory 40. A digital value of video signal from the TV camera 1 is written into the memory 40. On the other hand, as for reading out data from the memory 40, a desired offset amount is added to the read address counter 42, which integrates read addresses corresponding to scanning of the TV monitor 3 with the synchronous signals HSYNC2 and VSYNC2 from the read/write control circuit 45 and then, this is transmitted to the memory 40. Address data in which an offset is added to the read address is read out from the memory 40 and sent to the read data buffer 47. Then, when output from the read data buffer 47 is permitted, image data is outputted from the same buffer 47. Consequently, the image outputted from the read data buffer 47 is an image turned at 90° with respect to a captured image with the TV camera

Second Embodiment

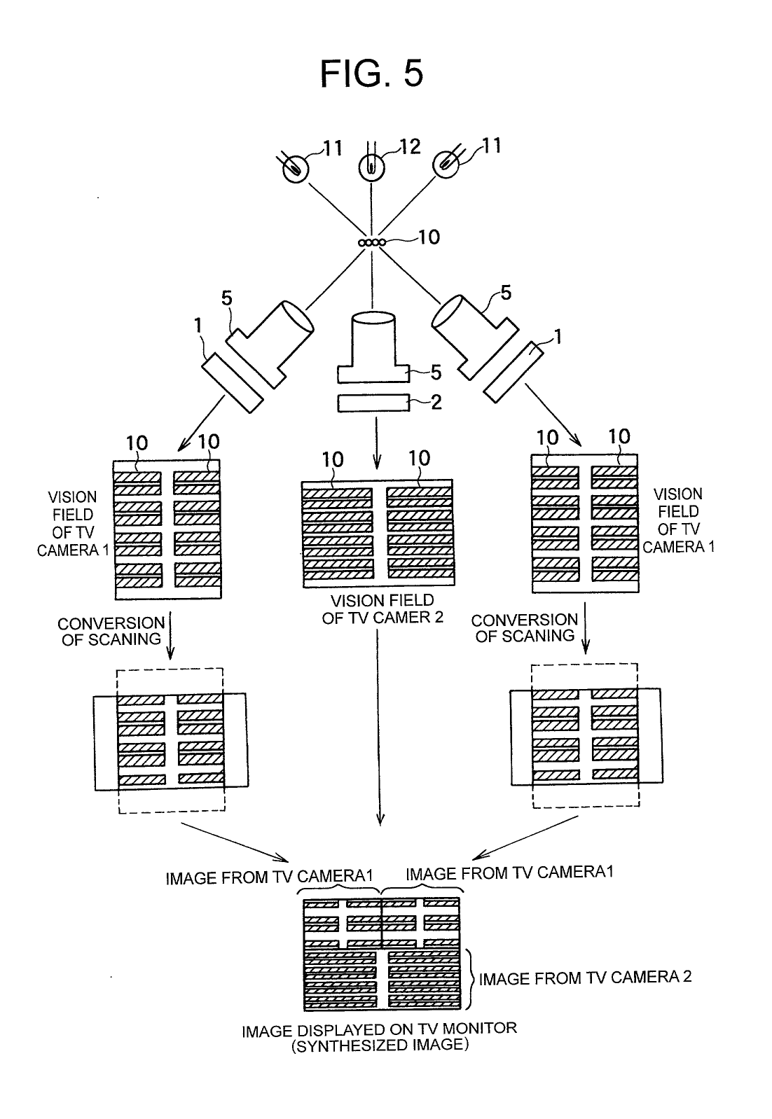

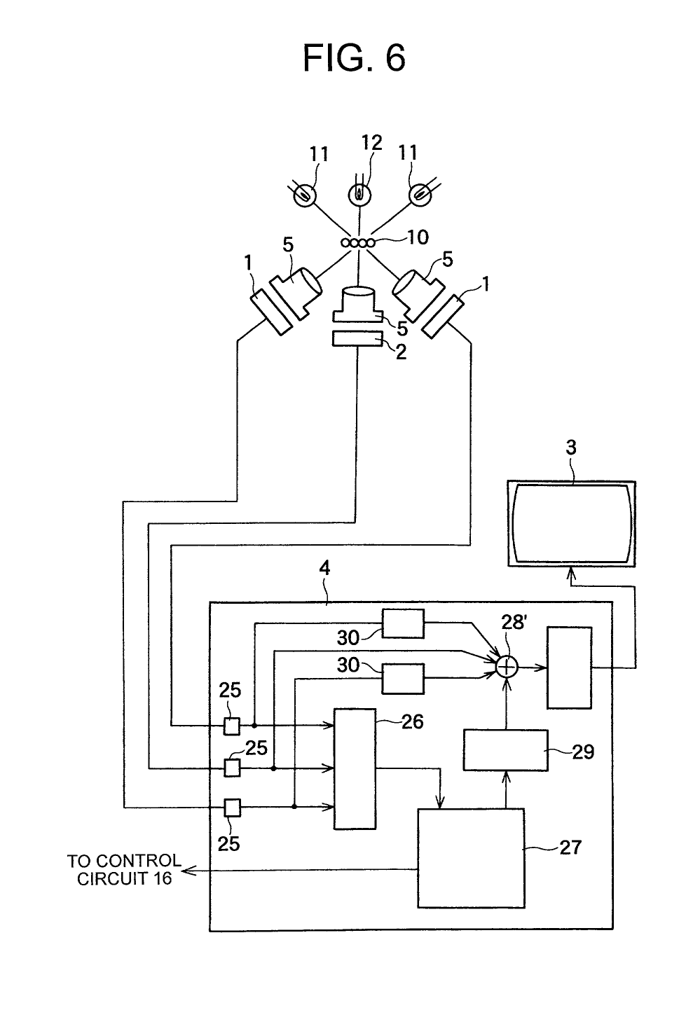

FIG. 5 shows a principle of the other embodiment of an observing apparatus for the optical fiber, optical parts of the present invention. In this apparatus, one more group of the light source 11, the microscope 5 and the TV camera 1 is added to the apparatus shown in FIG. 3 in order to execute observations from different two directions at a high magnification. In the observing apparatus for the optical fiber, optical components of the present invention in which the principle shown in FIG. 5 is embodied, as shown in FIG. 6, another video signal input system is added to the image processing portion 4 and correspondingly, another scanning converter 30 is added.

Industrial Availability

The observing apparatus for the optical fiber, optical component of the present invention has the following effect.

(1) Because a high magnification optical system is provided on a vertically-placed TV camera and a low magnification optical system is provided on a laterally-placed TV camera, both an image captured in a wide field of vision at a low magnification suitable for initial positioning and an image captured in a narrow field of vision at a high magnification suitable for final positioning are obtained.

(2) Because the vertically-placed TV camera for capturing images in order to execute high-magnification observation is disposed in such a direction that its scanning line orthogonal to the optical axis of the optical fiber and the like, a high resolution observation image can be obtained in a direction of axis shift of the same fiber.

(3) Because the scanning converter is provided so as to match signal system of the vertically-placed TV camera with signal system of the laterally-placed TV camera thereby enabling synthesis or switch-over of both the signals, it is possible to provide a screen easy for an operator to see.

(4) Due to the above described effects, an observation image suitable for alignment of the optical axis of a ribbon fiber comprised of a number of optical fibers can be obtained, so that particularly, an image suitable for alignment of the optical axis of a ribbon fiber comprised of eight or more optical fibers can be obtained.

(5) Not only the effects (1)-(4) described above are obtained when an ordinary TV camera whose ratio of its resolution capacity is 4:3 is employed, but also the same effects are obtained when, for example, a TV camera whose ratio of its resolution capacity is 16:9 such as a high-vision TV camera is employed. That is, any TV camera whose resolution capacity in its lateral direction is higher than that in its vertical direction can ensure the above-described effects (1)-(4).

1. An observing apparatus for optical fiber, optical component for observing said optical fiber and the like based on an image obtained by processing an image captured with two or more TV cameras about said optical fiber, said optical component, said observing apparatus comprising a vertically-placed TV camera disposed such that the direction of scanning lines thereof is orthogonal to the optical axis of said optical fiber or the like which is an object for capturing image and a laterally-placed TV camera disposed such that the direction of scanning line is parallel to the optical axis of the same optical fiber or the like, so that an image obtained by processing the image captured with these TV cameras is displayed on the TV monitor so as to observe said optical fiber, said optical component.

2. An observing apparatus for optical fiber, optical component for observing said optical fiber and the like based on an image obtained by processing an image captured with two or more TV cameras about said optical fiber, said optical component, said observing apparatus comprising a vertically-placed TV camera disposed such that the direction of scanning lines thereof is orthogonal to the optical axis of said optical fiber or the like which is an object for capturing image, a laterally-placed TV camera disposed such that the direction of scanning line is parallel to the optical axis of the same optical fiber or the like, and an image processing portion capable of outputting the image from these TV cameras to a TV monitor and further processing an image from the TV camera and outputting desired information about said optical fiber and the like, said TV camera containing an optical system for capturing images of the optical fiber or the like which is an object of capturing images, in enlargement, the optical system provided on the vertically-placed TV camera ensuring a higher magnification than the optical system provided on the laterally-placed TV camera, said image processing portion capable of turning an image sent from the vertically-placed TV camera at 90° , matching an image sent from the laterally-placed TV camera therewith in terms of their scanning directions and outputting the image to the TV monitor.

3. An observing apparatus for the optical fiber, optical component according to claim 1 or 2, wherein the image from the respective TV cameras can be reduced and outputted to the TV monitor as an image for a single screen and images from the respective TV cameras are switched over and outputted to the TV monitor separately.
